(19) United States
(12) Patent Application Publication
(10) Pub. No.: US 2018/0275918 A1
(43) Pub. Date: Sep. 27, 2018

(54) SEMICONDUCTOR MEMORY DEVICE

(71) Applicant: Toshiba Memory Corporation, Tokyo (JP)

(72) Inventor: Yusuke TANEFUSA, Yokohama Kanagawa (JP)

(21) Appl. No.: 15/693,350

(22) Filed: Aug. 31, 2017

(30) Foreign Application Priority Data
Mar. 23, 2017 (JP) 2017-058106

(51) Int. Cl. G06F 3/06

(52) U.S. Cl. CPC G06F 3/0659; G06F 3/0679; G06F 3/0604

(57) ABSTRACT

A semiconductor memory device includes a memory cell array including a plurality of planes that are independently operable, a plurality of first output terminals through which data read from the memory cell array are output, a second output terminal through which a ready/busy signal indicating a ready/busy state of the memory cell array is output, a control circuit configured to generate a first signal indicating a ready/busy state of each of the plurality of planes, and a signal converter configured to convert the first signal to a second signal indicating a ready/busy state of each of the plurality of planes, the second signal being output through the second output terminal.

### CROSS-REFERENCE TO RELATED APPLICATION

This application is based upon and claims the benefit of priority from Japanese Patent Application No. 2017-058106, filed Mar. 23, 2017, the entire contents of which are incorporated herein by reference.

### FIELD

Embodiments described herein relate generally to a semiconductor memory device.

### BACKGROUND

A NAND flash memory is widely known as a memory device.

### DESCRIPTION OF THE DRAWINGS

FIG. 1 illustrates a solid state drive (SSD) including a NAND flash memory according to embodiments.

FIG. 2 illustrates a configuration of a nonvolatile semiconductor memory according to a first embodiment.

FIG. 3 illustrates a table indicating a relationship between ready/busy states of memory planes and an output voltage of a ready/busy signal pin.

FIG. 4 illustrates a functional block of a controller.

FIG. 5 illustrates a relationship among a control circuit, a transistor switch, and the controller of a nonvolatile semiconductor memory of a second embodiment.

FIG. 6 illustrates a table that associates states of the memory planes, states of the transistor switches, and an output voltage of the ready/busy signal pin.

FIG. 7 illustrates a relationship among a control circuit, a pulse generator, and a controller of a nonvolatile semiconductor memory of a third embodiment.

FIG. 8 illustrates a table indicating a relationship between the states of the memory planes and an output frequency of the ready/busy signal pin.

FIG. 9 illustrates a relationship among a control circuit, a pulse generator, and a controller of a nonvolatile semiconductor memory of a fourth embodiment.

FIG. 10 is a waveform diagram illustrating a first example indicating a relationship between a write enable signal and a signal output from the ready/busy signal pin.

FIG. 11 is a waveform diagram illustrating a second example indicating a relationship between a write enable signal and a signal output from the ready/busy signal pin.

FIG. 12 illustrates a change of the states of the memory planes in the example of FIG. 11.

### DETAILED DESCRIPTION

An embodiment provides a semiconductor memory device that can efficiently output a state of each of a plurality of planes that is capable of independently performing operations.

In general, according to an embodiment, a semiconductor memory device includes a memory cell array including a plurality of planes that are independently operable, a plurality of first output terminals through which data read from the memory cell array are output, a second output terminal through which a ready/busy signal indicating a ready/busy state of the memory cell array is output, a control circuit configured to generate a first signal indicating a ready/busy state of each of the plurality of planes, and a signal converter configured to convert the first signal to a second signal indicating a ready/busy state of each of the plurality of planes, the second signal being output through the second output terminal.

Hereinafter, embodiments will be described with reference to the drawings.

### 1. First Embodiment

### 1-1. Configuration and Operation

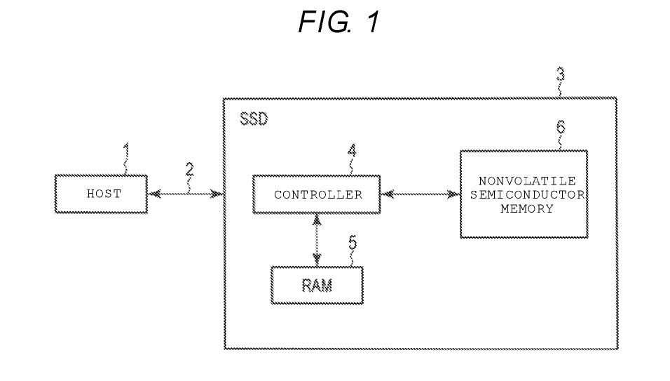

FIG. 1 illustrates a solid state drive (SSD) including a NAND flash memory according to embodiments.

As illustrated in FIG. 1, a host 1 is connected to an SSD 3 through a wired or a wireless network 2. The host 1 is, for example, a personal computer (PC) or a server.

The SSD 3 includes a controller 4, RAM 5, and a nonvolatile semiconductor memory 6.

The controller 4 performs overall control on the SSD 3 including communication between the host 1 and the SSD 3, a control of the SSD3, and a control of writing into and reading from the nonvolatile semiconductor memory 6.

The RAM 5 is used a working area for a program executed by the controller 4, and is, for example, a dynamic random access memory (DRAM).

The nonvolatile semiconductor memory 6 is, for example, a NAND flash memory, and stores data from the controller 4.

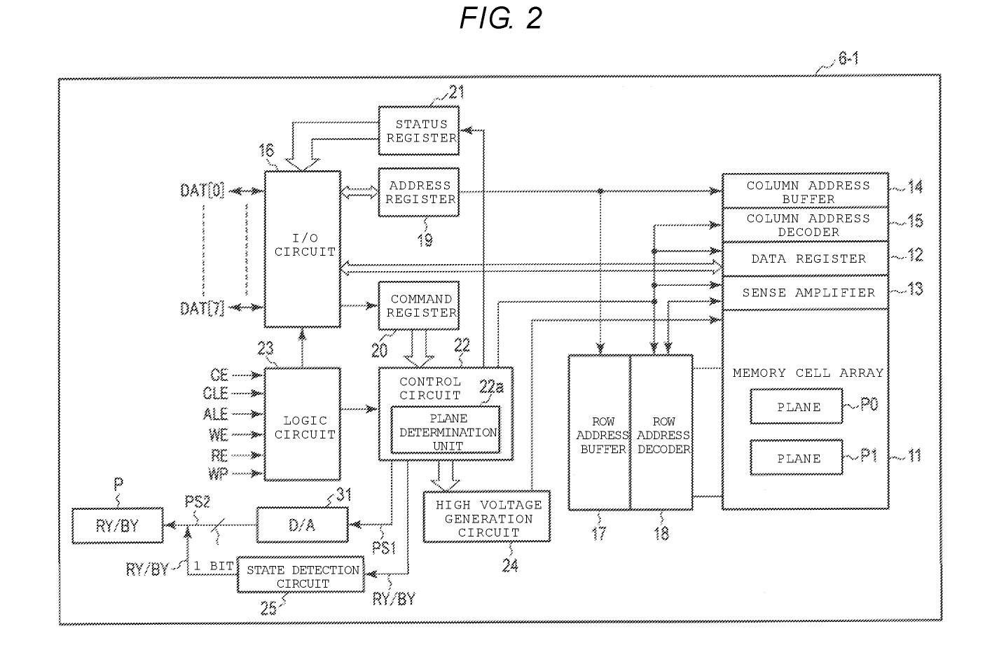

FIG. 2 illustrates a configuration of the nonvolatile semiconductor memory 6 according to the first embodiment.

The nonvolatile semiconductor memory 6 includes a memory cell array 11 and a data register 12 that temporarily stores program data or read data.

The memory cell array 11 includes a plurality of independently-controllable planes P0 and P1. In the embodiments, two planes P0 and P1 are illustrated, but the number of planes is not limited to two, and any plural numbers may be available. Each of the planes P0 and P1 includes a plurality of pages and at least one page register. The number of page registers depends on plane operations of the planes P0 and P1.

A sense amplifier 13 senses the read data and amplifies the read data. A column address buffer 14 buffers a column address signal. A column address decoder 15 decodes the column address signal and selects a column of the memory cell array 11.

In the embodiments, with regard to the selected 8 columns, the program data/read data (8 bit DAT [7:0]) is transferred between the data register 12 and an input/output (I/O) circuit 16.

A row address buffer 17 buffers a row address signal. A row address decoder 18 decodes the row address signal and selects one row (for example, 1 page) of the memory cell array 11.

An address register 19 temporarily stores the row address signal and the column address signal. A command register 20 temporarily stores, for example, a command signal for selecting a program operation, a reading operation, an erasing operation, or the like.

A status register 21 temporarily stores a result of a program verification operation (status pass/status fail). This result is transferred to the controller 4 of the nonvolatile semiconductor memory 6 and eventually to the host 1 at the outside of the nonvolatile semiconductor memory 6 via the I/O circuit 16.

The control circuit 22 controls various operations on the memory cell array 11 such as the program operation, the reading operation, or the erasing operation. In addition, the control circuit 22 includes a plane determination unit 22a that recognizes the ready/busy states of the planes P0 and P1 of the memory cell array 11. The plane determination unit 22a may recognize the ready/busy states of the planes P0 and P1 based on, for example, command information and address information, but not limited thereto. The plane determination unit 22a outputs a signal PS1 indicating the ready/busy states of the planes P0 and P1 to the D/A converter 31.

It is noted that in a case where a predetermined event occurs, the plane determination unit 22a may output the signal PS1 indicating the ready/busy states of the planes P0 and P1 to the D/A converter 31. The predetermined event includes a case where the write enable signal WE is received by the nonvolatile semiconductor memory 6, but not limited thereto.

The control circuit 22 does not inform the state detection circuit 25 of the current state of the nonvolatile semiconductor memory 6 while the plane determination unit 22a outputs the signal PS1 to the D/A converter 31. Therefore, the state detection circuit 25 does not output a ready/busy signal RY/BY of the nonvolatile semiconductor memory 6 to the ready/busy signal pin P while the plane determination unit 22a outputs the signal PS1 to the D/A converter 31.

In the embodiments, it is noted that the number of ready/busy signal pins P is one, but not limited to one. In addition, in the first embodiment, the ready/busy signal pin P is shared by the D/A converter 31 and the state detection circuit 25. However, only the D/A converter 31 may use the ready/busy signal pin P without providing the state detection circuit 25.

A logic circuit 23 receives a chip enable signal CE, a command latch enable signal CLE, an address latch enable signal ALE, the write enable signal WE, a read enable signal RE, and a write protect signal WP, and instructs the control circuit 22 to perform the operations based on these control signals.

The chip enable signal CE determines select/non-select of the chips.

When the command latch enable signal CLE is in an enable state, the input data (e.g., the command signal) is transferred to the command register 20. When the address latch enable signal ALE is in the enable state, the input data (e.g., the row/column address signal) is transferred to the address register 19.

When the write enable signal WE is in the enable state, the program operation is performed; when the read enable signal RE is in the enable state, the reading operation is performed. The write protect signal WP is a signal indicating a permission/prohibition of overwriting. When the write protect signal WP is in the enable state, the overwriting is prohibited. Therefore, the data already stored is not changed.

A high voltage generation circuit 24 generates a high voltage used at the time of the program operation, and supplies the high voltage to the memory cell array 11.

The state detection circuit 25 detects the current state of the nonvolatile semiconductor memory 6, and informs the controller 4 of the nonvolatile semiconductor memory 6 of the current status. For example, when the nonvolatile semiconductor memory 6 is in an operation, the ready/busy signal RY/BY indicates a busy state; when the nonvolatile semiconductor memory 6 is on standby, the ready/busy signal RY/BY indicates a ready state. The ready/busy signal RY/BY is output to the controller 4 via the ready/busy signal pin P.

When the signal PS1 indicating the ready/busy states of the planes P0 and P1 is received from the plane determination unit 22a of the control circuit 22, the D/A converter 31 outputs an analog signal PS2 having a voltage which is based on the received signal PS1 to the ready/busy signal pin P. That is, the signal PS2 or the ready/busy signal RY/BY is output from the ready/busy signal pin P.

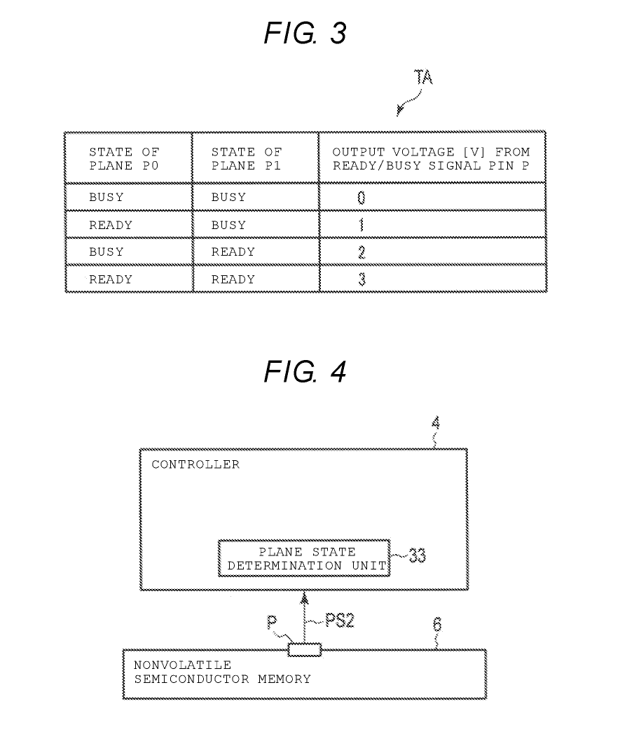

FIG. 3 illustrates a table TA indicating a relationship between the ready/busy states of the planes P0 and P1 indicated by the digital signal PS1 input to the D/A converter 31 and an output voltage [V] of the ready/busy signal pin P.

As illustrated in FIG. 3, in the digital signal PS1 input to the D/A converter 31, in a case where the state of the plane P0 is indicated as “busy” and the state of the plane P1 is indicated as “busy”, the output signal P2 from the D/A converter 31 is 0 [V] and a voltage 0 [V] of the output signal P2 is output from the ready/busy signal pin P.

In the received digital signal PS1, in a case where the state of the plane P0 is indicated as “ready” and the state of the plane P1 is indicated as “busy”, the output signal P2 from the D/A converter 31 is 1 [V] and a voltage 1 [V] of the output signal P2 is output from the ready/busy signal pin P. In the digital signal PS1, in a case where the state of the plane P0 is indicated as “busy” and the state of the plane P1 is indicated as “ready”, the output signal P2 from the D/A converter 31 is 2 [V] and a voltage 2 [V] of the output signal P2 is output from the ready/busy signal pin P. In the digital signal PS1, in a case where the state of the plane P0 is indicated as “ready” and the state of the plane P1 is indicated as “ready”, the output signal P2 from the D/A converter 31 is 3 [V] and a voltage 3 [V] of the output signal P2 is output from the ready/busy signal pin P.

FIG. 4 illustrates a functional block of a controller 4. As illustrated in FIG. 4, the controller 4 includes a plane state determination unit 33. The plane state determination unit 33 receives the analog signal PS2 output from the ready/busy signal pin P of the nonvolatile semiconductor memory 6, and recognizes the ready/busy states of the planes P0 and P1 based on the voltage of the received analog signal PS2. For example, the recognition of the ready/busy states of the planes P0 and P1 is determined using the table TA illustrated in FIG. 3.

As illustrated in FIG. 4, in a case where the output voltage of the signal P2 from the ready/busy signal pin P is 0 [V], the plane state determination unit 33 determines that the state of the plane P0 is “busy” and the state of the plane P1 is “busy” using the table TA.

The plane state determination unit 33 determines that the state of the plane P0 is “ready” and the state of the plane P1 is “busy” in a case where the output voltage of the signal P2 is 1 [V], that the state of the plane P0 is “busy” and the state of the plane P1 is “ready” in a case where the output voltage of the signal P2 is 2 [V], and that the state of the plane P0 is “ready” and the state of the plane P1 is “ready” in a case where the output voltage of the signal P2 is 3 [V].

### 1-2. Effects

In the semiconductor memory device including a plurality of planes capable of operating independently, the plurality of planes performs writing/reading/erasing operations simultaneously. Such a semiconductor memory device has a circuit that can determine from the ready/busy signal pin P only whether the semiconductor memory device is in a ready state or in a busy state.

In a case where controller issues a command to check the ready/busy state of each plane and the state of each plane is determined from the plurality of I/O pins, since the I/O path is occupied when the ready/busy state of each plane is checked, it is not possible to input or output the data or to issue the command.

According to the semiconductor memory device of the first embodiment, the signal PS2 having the voltage representing the state of the planes P0 and P1 of the memory cell array 11 is output from the nonvolatile semiconductor memory 6 via the ready/busy signal pin P.

For that reason, the controller 4 of the nonvolatile semiconductor memory 6 can determine the states of the plurality of planes capable of independent operation with high efficiency based on the signal PS2 output from the ready/busy signal pin P.

In addition, by determining the states of the planes without passing through an I/O circuit 16 of the nonvolatile semiconductor memory 6, it is possible to recognize whether or not the writing, reading, and erasing operations of the planes P0 and P1 are finished. Therefore, there is no need to reduce the number of accesses to the I/O that can be processed per one second. Therefore, it is possible to efficiently perform the writing, reading, and erasing operations for each plane.

### 2. Second Embodiment

### 2-1. Configuration and Operation

A nonvolatile semiconductor memory 6 of a second embodiment includes a transistor switch SW instead of the D/A converter 31 illustrated in FIG. 2. The transistor switch SW includes transistor switches SW1 and SW2 corresponding to the planes P0 and P1, respectively. Impedances of the transistor switches SW1 and SW2 are different from each other.

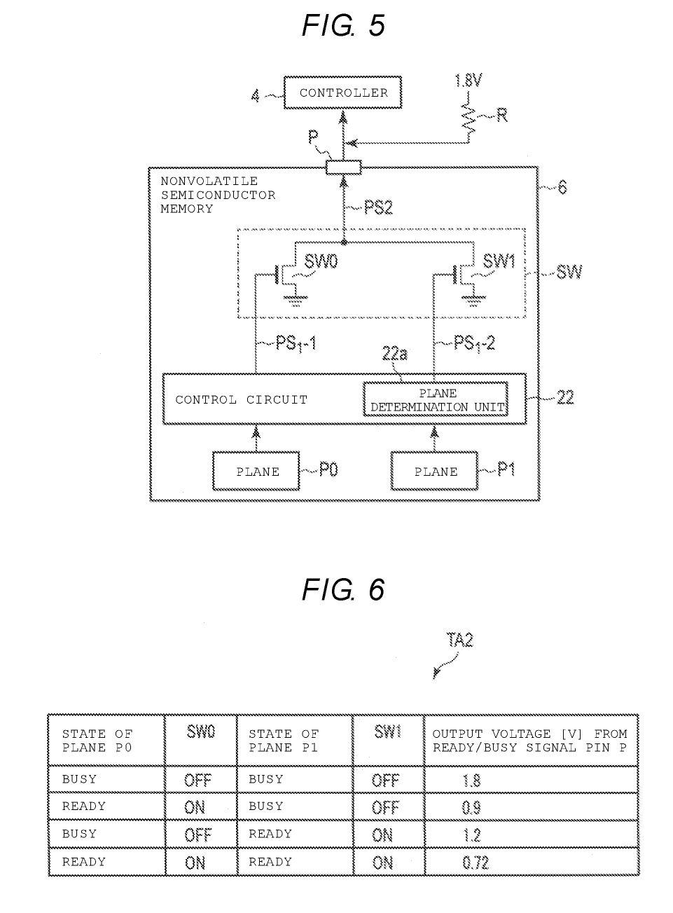

FIG. 5 illustrates a relationship among the control circuit 22, the transistor switch SW, and the controller 4 of the nonvolatile semiconductor memory 6 of the second embodiment. It is noted that descriptions will be made using the same reference signs for the same elements as those in FIG. 2.

In FIG. 5, the plane determination unit 22a of the control circuit 22 recognizes the ready/busy states of the planes P0 and P1 of the memory cell array 11. The plane determination unit 22a performs the ON/OFF control of the transistor switches SW0 and SW1 based on the ready/busy states of the planes P0 and P1.

Specifically, the transistor switch SW0 is turned off in a case where the state of the plane P0 is “busy”, the transistor switch SW0 is turned on in a case where the state of the plane P0 is “ready”, the transistor switch SW1 is turned off in a case where the state of the plane P1 is “busy”, and the transistor switch SW1 is turned on in a case where the state of the plane P1 is “ready”.

The transistor switches SW0 and SW1 of the transistor switch SW are connected in parallel between the control circuit 22 and the ready/busy signal pin P. The voltages of the output signals PS1-1 and PS1-2 from the plane determination unit 22a of the control circuit 22 are respectively applied to gates of the transistors of the transistor switches SW0 and SW1 for performing the ON/OFF control based on the ready/busy states of the planes P0 and P1.

Sources of the transistor of the transistor switches SW0 and SW1 are grounded, and drains are commonly connected to the ready/busy signal pin P. In the second embodiment, resistance value of each of the transistor switches SW0 and SW1 in the OFF state are assumed to be 1 [kΩ] and 2 [kΩ] respectively.

To the ready/busy signal pin P, the controller 4 is connected and a constant voltage 1.8 [V] is applied via a resistor R. In the second embodiment, a value of the resistor R is 1 [kΩ]. In a case where the transistor switches SW0 and SW1 are in the OFF state, the current is not flowing in the nonvolatile semiconductor memory 6 and the controller 4 and the voltage applied to the ready/busy signal pin P is 1.8 [V].

FIG. 6 illustrates a table TA2 indicating a relationship among the states of the planes P0 and P1, the states of the transistor switches SW0 and SW1, and the output voltage of the ready/busy signal pin P according to the present embodiment. As illustrated in FIG. 6, in a case where the state of the plane P0 is indicated as “busy” and the state of the plane P1 is indicated as “busy”, the transistor switches SW0 and SW1 are in the OFF state, and the voltage of the ready/busy signal pin P is 1.8 [V].

In a case where the state of the plane P0 is indicated as “ready” and the state of the plane P1 is indicated as “busy”, the transistor switch SW0 is in the OFF state and the transistor switch SW1 is in the OFF state and the voltage of the ready/busy signal pin P is 0.9 [V], in a case where the state of the plane P0 is indicated as “busy” and the state of the plane P1 is indicated as “ready”, the transistor switch SW0 is in the OFF state and the transistor switch SW1 is in the ON state and the voltage of the ready/busy signal pin P is 1.2 [V], and in a case where the states of the planes P0 and P1 are indicated as “ready”, the transistor switches SW0 and SW1 are in ON state and the voltage of the ready/busy signal pin P is 0.72 [V].

Similarly to FIG. 4, the controller 4 includes the plane state determination unit 33. The plane state determination unit 33 receives the signal PS2 from the ready/busy signal pin P of the nonvolatile semiconductor memory 6, and recognizes the ready/busy states of the planes P0 and P1 based on the voltage of the received signal PS2. The recognition of the ready/busy states of the planes P0 and P1 is determined using the table TA2 illustrated in FIG. 6.

As illustrated in FIG. 6, in a case where the output voltage of the signal P2 from the ready/busy signal pin P is 0 [V], the plane state determination unit 33 determines that the state of the plane P0 is “busy” and the state of the plane P1 is “busy” using the table TA2.

The plane state determination unit 33 determines that the state of the plane P0 is “ready” and state of the plane P1 is “busy” in a case where the output voltage of the signal P2 is 0.9 [V], that the state of the plane P0 is “busy” and the state of the plane P1 is “ready” in a case where the output voltage of the signal P2 is 1.2 [V], that the state of the plane P0 is “ready” and the state of the plane P1 is “ready” in a case where the output voltage of the signal P2 is 0.72 [V].

### 2-2. Effects

According to the semiconductor memory device of the second embodiment, the ready/busy states of the planes P0 and P1 are determined by providing the transistor switch SW instead of the D/A converter 31. Therefore, according to the semiconductor memory device of the second embodiment, it is possible to provide a semiconductor memory device with a simpler configuration compared to that of the first embodiment in addition to the effects of the semiconductor memory device of the first embodiment.

### 3. Third Embodiment

### 3-1. Configuration and Operation

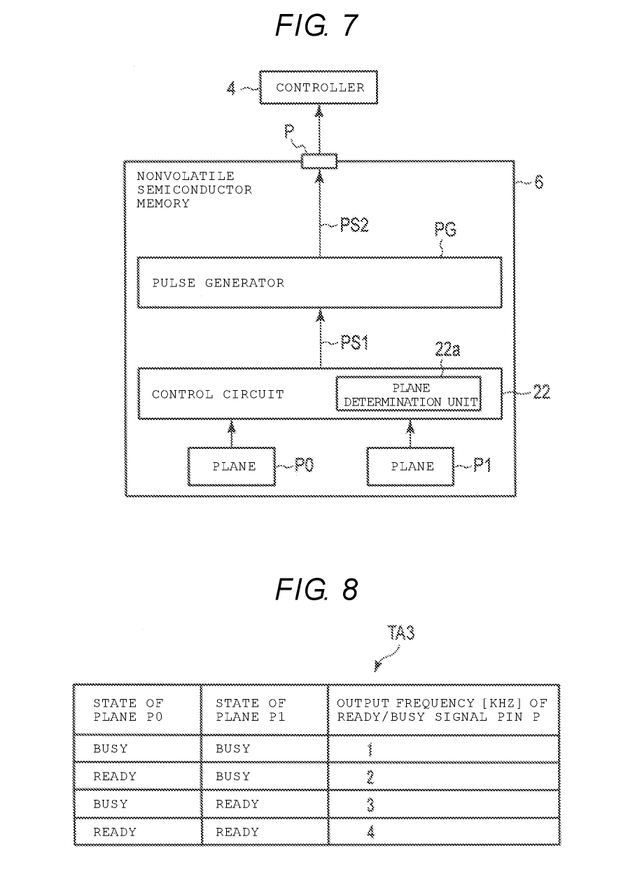

A nonvolatile semiconductor memory 6 of a third embodiment includes a pulse generator PG instead of the D/A converter 31 illustrated in FIG. 2. FIG. 7 illustrates a relationship among the control circuit 22, the pulse generator PG, and the controller 4 of the nonvolatile semiconductor memory 6 of the third embodiment. It is noted that descriptions will be made using the same reference signs for the same elements as those in FIG. 2.

The plane determination unit 22a of the control circuit 22 recognizes the ready/busy states of the planes P0 and P1 of the memory cell array 11. The plane determination unit 22a outputs a signal PS1 indicating the ready/busy states of the planes P0 and P1 to the pulse generator PG.

The pulse generator PG generates a signal PS2 having a pulse frequency indicating the ready/busy states of the planes P0 and P1 based on the signal PS1, and outputs the generated signal PS2 to the ready/busy signal pin P.

FIG. 8 illustrates a table TA3 indicating a relationship among the states of the planes P0 and P1 and the output frequency [kHz] of the ready/busy signal pin P. As illustrated in the drawing, in a case where the state of the plane P0 is indicated as “busy” and the state of the plane P1 is indicated as “busy”, the output frequency of the pulse generator PG is 1 [kHz] and the output signal P2 having the output frequency 1 [kHz] is output from the ready/busy signal pin P.

In a case where the state of the plane P0 is indicated as “ready” and the state of the plane P1 is indicated as “busy”, the output frequency of the pulse generator PG is 2 [kHz] and the output signal P2 having the output frequency 2 [kHz] is output from the ready/busy signal pin P. In a case where the state of the plane P0 is indicated as “busy” and the state of the plane P1 is indicated as “ready”, the output frequency of the pulse generator PG is 3 [kHz] and the output signal P2 having the output frequency 3 [kHz] is output from the ready/busy signal pin P. In a case where the state of the plane P0 is indicated as “ready” and the state of the plane P1 is indicated as “ready”, the output frequency of the pulse generator PG is 4 [kHz] and the output signal P2 having the output frequency 4 [kHz] is output from the ready/busy signal pin P.

Similarly to FIG. 4, the controller 4 includes the plane state determination unit 33. The plane state determination unit 33 receives the signal PS2 from the ready/busy signal pin P of the nonvolatile semiconductor memory 6, and recognizes the ready/busy states of the planes P0 and P1 based on the pulse frequency of the received signal PS2. The recognition of the ready/busy states of the planes P0 and P1 is determined using the table TA3 illustrated in FIG. 8.

As illustrated in FIG. 8, in a case where the output frequency of the signal P2 from the ready/busy signal pin P is 1 [kHz], the plane state determination unit 33 determines that the state of the plane P0 is “busy” and the state of the plane P1 is “busy” using the table TA3.

The plane state determination unit 33 determines that the state of the plane P0 is “ready” and state of the plane P1 is “busy” in a case where the output frequency of the signal P2 is 2 [kHz], that the state of the plane P0 is “busy” and the state of the plane P1 is “ready” in a case where the output frequency of the signal P2 is 3 [kHz], that the state of the plane P0 is “ready” and the state of the plane P1 is “ready” in a case where the output frequency of the signal P2 is 4 [kHz].

### 3-2. Effects

According to the semiconductor memory device of the third embodiment, the pulse generator PG is provided instead of the D/A converter 31, the signals PS2 having pulse frequency different from each other indicating the state of the planes P0 and P1 is output from the ready/busy signal pin P of the nonvolatile semiconductor memory 6. Therefore, the controller 4 can determine the ready/busy states of the planes P0 and P1 based on the pulse frequency of the signal PS2 output from the ready/busy signal pin P.

### 4. Fourth Embodiment

### 4-1. Configuration and Operation

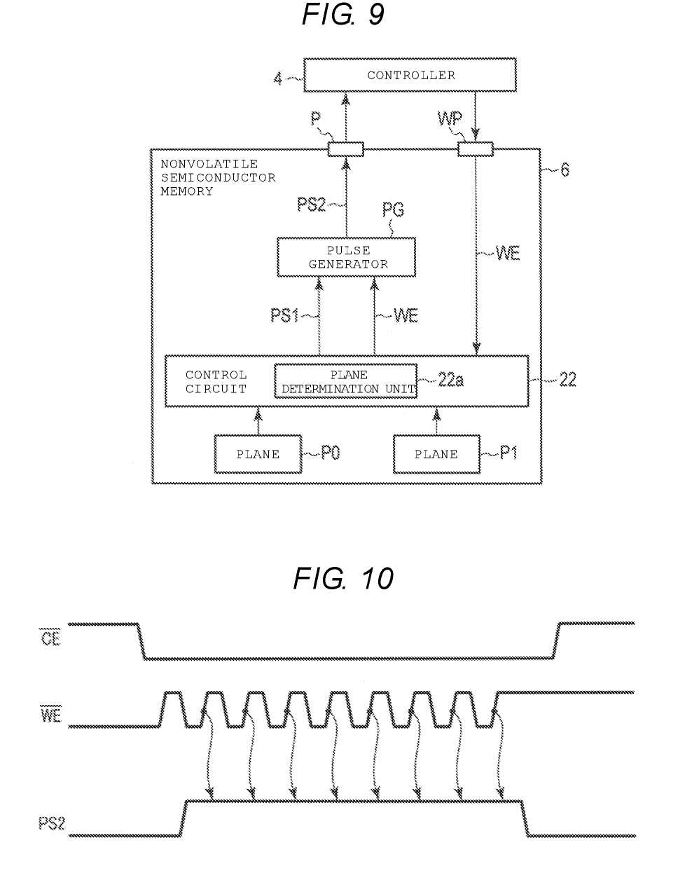

A nonvolatile semiconductor memory 6 of a fourth embodiment includes a pulse generator PG instead of the D/A converter 31 illustrated in FIG. 2. FIG. 9 illustrates a relationship among the control circuit 22, the pulse generator PG, and the controller of the nonvolatile semiconductor memory 6 of the fourth embodiment. It is noted that descriptions will be made using the same reference signs for the same elements as those in FIG. 2.

The plane determination unit 22a of the control circuit 22 recognizes the ready/busy states of the planes P0 and P1 of the memory cell array 11. The plane determination unit 22a outputs a signal PS1 indicating the ready/busy states of the planes P0 and P1 to the pulse generator PG. In addition, the control circuit 22 receives a write enable signal WE sent from the controller 4 via a write enable WP, and outputs the write enable signal WE to the pulse generator PG.

The pulse generator PG receives the signal PS1 and generates a pulse signal PS2 having a voltage indicating the ready/busy states of the planes P0 and P1 from the received signal PS1 and outputs the pulse signal PS2 while synchronizing with the signal WE.

In the fourth embodiment, the pulse signals PS2 having the voltages indicating the ready/busy states of the planes P0 and P1 are alternately output from the pulse generator PG while being synchronized with the signal WE. The voltages indicating the ready/busy states of the planes P0 and P1 is represented by, for example, 1 [V] or 0 [V].

Similarly to FIG. 4, the controller 4 includes the plane state determination unit 33. The plane state determination unit 33 receives the signal PS2 from the ready/busy signal pin P of the nonvolatile semiconductor memory 6, and recognizes the ready/busy states of the planes P0 and P1 based on the voltage of the received signal PS2 while synchronizing with the signal WE.

In the fourth embodiment, it is assumed that the controller 4 determines the ready/busy states of the planes P0 and P1 while the write enable signal WE is output to the nonvolatile semiconductor memory 6. For example, in a case where the pulse generator PG of the nonvolatile semiconductor memory 6 alternately outputs the signals indicating the state of the planes P0 and P1 while synchronizing with eight rising edges of the write enable signal WE input from the controller 4 via the control circuit 22, the states of the planes P0 and P1 are determined four times by the controller 4 based on the signal PS2 output from the ready/busy signal pin P.

It is noted that the pulse generator PG of the nonvolatile semiconductor memory 6 may use falling edges of the write enable signal WE or may output the signal PS2 using both the rising edges and the falling edges.

FIG. 10 is a waveform diagram illustrating a first example indicating a relationship between the write enable signal WE and the signal PS2 output from the ready/busy signal pin P.

In FIG. 10, at the entire timing of synchronizing with eight rising edges of the write enable signal WE, both the states of the planes P0 and P1 are “ready” states, and “1” is output from the ready/busy signal pin P.

Since both the states of the planes P0 and P1 are “ready” states while synchronizing with eight rising edges of the write enable signal WE and the state of the planes P0 and P1 are not changed, the pulse generator PG continues to alternately output the signal PS2 of “1” (1 [V]) for the planes P0 and P1.

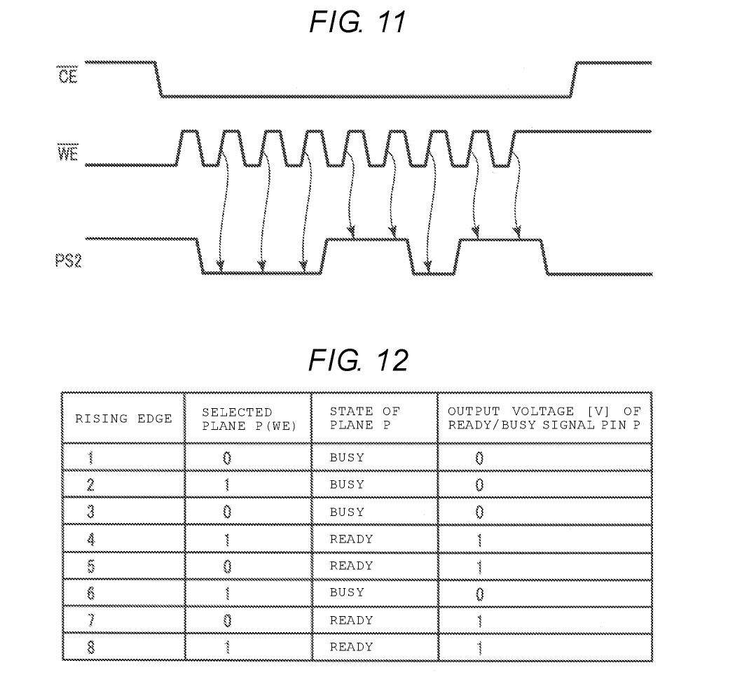

FIG. 11 is a waveform diagram illustrating a second example indicating a relationship between the write enable signal WE and a signal PS2 output from the ready/busy signal pin P. The drawing illustrates a case where the state of the planes P0 and P1 change at the timing of eight rising edges of the write enable signal WE. FIG. 12 illustrates the change of the states of the planes P0 and P1 corresponding to FIG. 11.

As illustrated in FIG. 11 and FIG. 12, with synchronizing with the timing of eight rising edges of the write enable signal WE, the output voltage [V] from the ready/busy signal pin P changes as “0”→“0”→“0”→“1”→“1”→“0”→“1”→“1”. Therefore, the state of [plane P0, plane P1] changes as [busy, busy]→[busy, ready], →[ready, busy], →[ready, ready].

In the fourth embodiment, the description is made for a case where the write enable signal WE is received, but the cases where the above-described operations is carried out are not limited thereto and may be any predetermined events. For example, the cases may include a case where the nonvolatile semiconductor memory 6 firstly receives the write enable signal WE or a case where a chip enable signal CE is received.

In addition, the description is made using a case where the eight rising edges of the write enable signal WE are used to determine the ready/busy states, but the criteria to determine the ready/busy state is not limited thereto. In a case of using the rising edges (or the falling edges) of the write enable signal WE, any signals may be used as long as the signal has the timing signals as many as the number of planes. For example, in a case of two planes P0 and P1, any timing signals having at least two rising edges (or falling edges) may be used. In a case of using the rising and falling edges of the timing signal and in a case of two planes P0 and P1, at least one timing signal may be used.

Furthermore, the description is made using a case where the state of the planes P0 and P1 is determined by the controller 4 based on the voltage, but as described in the third embodiment, the state of the planes P0 and P1 may be determined based on the pulse frequency.

### 4-2. Effects

According to the semiconductor memory device of the fourth embodiment, it is possible to determine the state of the planes P0 and P1 at the time when a predetermined event occurs. In addition, in a case where the predetermined event continues to occur, the controller 4 can determine the state of the planes P0 and P1 in a predetermined time in real time.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor memory device comprising:
a memory cell array including a plurality of planes that are independently operable;
a plurality of first output terminals through which data read from the memory cell array are output;
a second output terminal through which a ready/busy signal indicating a ready/busy state of the memory cell array is output;
a control circuit configured to generate a first signal indicating a ready/busy state of each of the plurality of planes; and
a signal converter configured to convert the first signal to a second signal indicating a ready/busy state of each of the plurality of planes, the second signal being output through the second output terminal.

2. The semiconductor memory device according to claim 1, wherein
when the ready/busy signal is output through the second output terminal, the second signal is not output through the second output terminal, and
when the second signal is output through the second output terminal, the ready/busy signal is not output through the second output terminal.

3. The semiconductor memory device according to claim 1, further comprising:
a controller configured to determine the ready/busy state of each of the plurality of planes based on the second signal output through the second output terminal.

4. The semiconductor memory device according to claim 1, wherein
the signal converter includes a digital-to-analog converter configured to generate an analog signal from the first signal as the second signal, and a voltage of the analog signal indicates the ready/busy state of each of the plurality of planes.

5. The semiconductor memory device according to claim 1, wherein
the signal converter includes a plurality of switching elements connected in parallel between the control circuit and the second output terminal, each of the switching element having an on/off state corresponding to the first signal, and a voltage of the second signal that corresponds to the on/off state of each of the plurality of switching elements indicates the ready/busy state of each of the plurality of planes.

6. The semiconductor memory device according to claim 1, wherein
the signal converter includes a pulse generator configured to generate a pulse signal from the first signal as the second signal, and a frequency the pulse signal indicates the ready/busy state of each of the plurality of planes.

7. The semiconductor memory device according to claim 1, wherein
the signal converter includes a pulse generator configured to generate a pulse signal from the first signal as the second signal in synchronization with a timing signal input from an external module, and
a first pulse of the pulse signal indicates the ready/busy state of one of the plurality of planes, and a second pulse of the pulse signal indicates the ready/busy state of another one of the plurality of planes.

8. The semiconductor memory device according to claim 1, wherein the timing signal is a write enable signal or a chip enable signal.

9. The semiconductor memory device according to claim 1, wherein
the pulse generator generates the pulse signal in synchronization with a rising edge or a falling edge of the timing signal.

10. The semiconductor memory device according to claim 1, wherein
the control circuit generates the first signal based on a command and an address received by the plurality of first output terminals from an external module.

11. A semiconductor memory device comprising:
a memory cell array including a plurality of planes that are independently operable;
a plurality of first output terminals through which data read from the memory cell array are output; and
a second output terminal through which a first ready/busy signal indicating a ready/busy state of the memory cell array and a second ready/busy signal indicating a ready/busy state of each of the plurality of planes are output.

12. The semiconductor memory device according to claim 11, wherein
when the first ready/busy signal is output through the second output terminal, the second read/busy signal is not output through the second output terminal, and
when the second read/busy signal is output through the second output terminal, the first ready/busy signal is not output through the second output terminal.

13. The semiconductor memory device according to claim 11, wherein
a voltage of the second ready/busy signal indicates the ready/busy state of each of the plurality of planes.

14. The semiconductor memory device according to claim 11, wherein
a frequency of the second ready/busy signal indicates the ready/busy state of each of the plurality of planes.

15. The semiconductor memory device according to claim 11, wherein
a voltage of a first pulse of the second ready/busy signal indicates the ready/busy state of one of the plurality of planes, and a voltage of a second pulse of the second ready/busy signal indicates the ready/busy state of another one of the plurality of planes.

16. The semiconductor memory device according to claim 11, wherein
the data read from the memory cell array are not output through the second output terminal, and the second signal is not output through any of the first output terminals.

17. A method for operating a semiconductor memory device having a memory cell array including a plurality of planes that are independently operable, the method comprising:
outputting data read from the memory cell array through a plurality of first output terminals;
outputting a first ready/busy signal indicating a ready/busy state of the memory cell array through a second output terminal; and
outputting a second ready/busy signal indicating a ready/busy state of each of the plurality of planes through the second output terminal.

18. The method according to claim 17, wherein
when the first ready/busy signal is output through the second output terminal, the second read/busy signal is not output through the second output terminal, and
when the second read/busy signal is output through the second output terminal, the first ready/busy signal is not output through the second output terminal.

19. The method according to claim 17, wherein
a voltage of the second ready/busy signal indicates the ready/busy state of each of the plurality of planes.

20. The method according to claim 17, wherein
a frequency of the second ready/busy signal indicates the ready/busy state of each of the plurality of planes.
